(19) United States
(12) Patent Application Publication
(10) Pub. No.: US 2021/0262548 A1
(43) Pub. Date: Aug. 26, 2021

(54) LATERAL REARVIEW MIRROR MEMBER FOR VIBRATION CONTROL

(71) Applicant: BASF SE, Ludwigshafen am Rhein (DE)

(72) Inventors: Ricardo Mercado, Wyandotte, MI (US); Brian E. Shaner, Wyandotte, MI (US); Sebastian Pricker, Lemfoerde (DE)

(21) Appl. No.: 17/252,085

(22) PCT Filed: Jun. 21, 2019
(86) PCT No.: PCT/US2019/038389

§ 371 Date: Dec. 14, 2020

Related U.S. Application Data
(60) Provisional application No. 62/691,984, filed on Jun. 29, 2018.

(51) Int. Cl. F16F 15/08; B60R 1/06

(52) U.S. Cl. CPC F16F 15/08; B60R 1/06; F16F 2230/02; F16F 2224/02; F16F 2224/0225; F16F 2226/04; F16F 2234/02; F16F 2224/025; F16F 2228/007

(57) ABSTRACT

A vibration-resistant lateral rearview mirror system (100) having a base bracket (101) for mounting the lateral rearview mirror system to a vehicle, a mirror assembly (103) having a reflective element, a support on the base bracket for mounting the mirror assembly to the base bracket, and an elastomeric vibration dampener positioned in the mirror assembly in a compressed state is described. The vibration dampener (105) applies a biased force against the mirror assembly and absorbs vibrational energy between the mirror assembly and the base bracket.

### TECHNICAL FIELD

This disclosure relates to a lateral rearview mirror, more particularly, to an exterior rearview mirror for mounting on a vehicle which is resistant to vibration.

### BACKGROUND

The primary function of a lateral rearview mirror, also referred to as a “side view” mirror, is to provide a clear image of the driver's surroundings. Vision capability is compromised when excessive vibration is transferred from the car door to the mirror glass. This effect, referred to as “image blurring,” could represent a safety issue and must be addressed during lateral rearview mirror assembly development. To that end, mirror brackets have historically been made of metal, like aluminum and magnesium, due their high levels of stiffness, which provides the necessary rigidity to minimize the effect of mirror glass vibration.

FIG. 1 shows a conventional lateral rearview mirror system 10. The conventional lateral rearview mirror system 10 comprises a base bracket 1 made of metal for mounting the lateral rearview mirror system to the door 2 of a vehicle. Lateral rearview mirror system 10 also includes mirror assembly 3 having a metal housing bracket 3a, front housing 3b, back housing 3c, and a reflective element 3d that is mountable to the support 4 of the base bracket 1. The lateral rearview mirror system 10 further includes a metal spring 5 positioned on the support 4 between the base bracket 1 and mirror assembly 3. The use of as stiff metal to fabricate at least portions of the mirror assembly 3 and the base bracket 1 helps to reduce vibration.

However, metal components can lead to increased weight and the automotive industry has been seeking to reduce the weight of components for economic and ecologic reasons. Composite materials including plastic have been presented as an alternative or partial replacement for metal materials. Unfortunately, plastics have lower stiffness compared to metals, which has been a barrier when trying to achieve the vibration levels required by the industry. While the metal springs can absorb some vibrational energy, they have low damping properties at small displacements, thereby resulting in a large percentage of vibration being transferred from the base bracket to the housing bracket. Accordingly, there is a need for a lateral rearview mirror system that can adequately dampen vibrational energy transfer to the mirror assembly even when the mirror system is partially fabricated from plastic material.

### SUMMARY

I provide a vibration-resistant lateral rearview mirror system comprising a base bracket for mounting the lateral rearview mirror system to a vehicle; a mirror assembly having a reflective element; a support on the base bracket for mounting the mirror assembly to the base bracket; an elastomeric vibration dampener positioned in the mirror assembly in a compressed state, wherein the vibration dampener applies a biased force against the mirror assembly and absorbs vibrational energy between the mirror assembly and the base bracket.

I also provide a method of making a vibration-resistant lateral rearview mirror system comprising providing a base bracket for mounting the lateral rearview mirror system to a vehicle, the base bracket comprising a support; positioning an elastomeric vibration dampener on the support; and coupling a mirror assembly having a reflective element to the support, wherein the vibration dampener is enclosed within the mirror assembly in a compressed state.

### DRAWINGS

FIG. 1 shows an exploded view of a conventional lateral rearview mirror system.

FIG. 2 shows a perspective view of portions of an exemplary lateral rearview mirror system of this disclosure.

FIG. 3 shows a split-view of a partial cross-section of an exemplary lateral rearview mirror system of this disclosure.

FIG. 4 is a perspective view of portions of an alternative exemplary lateral rearview mirror system of this disclosure.

FIG. 5 is a perspective view of an alternative exemplary vibration dampener.

### DETAILED DESCRIPTION

This disclosure relates to a lateral rearview mirror system for a vehicle that is able to reduce the transfer of vibration from the vehicle to the mirror system, thereby reducing image blurring. The lateral rearview mirror system of this disclosure utilizes an elastomeric vibration dampener which applies a biased force against the mirror assembly and absorbs vibrational energy transferred between the mirror assembly and the base bracket.

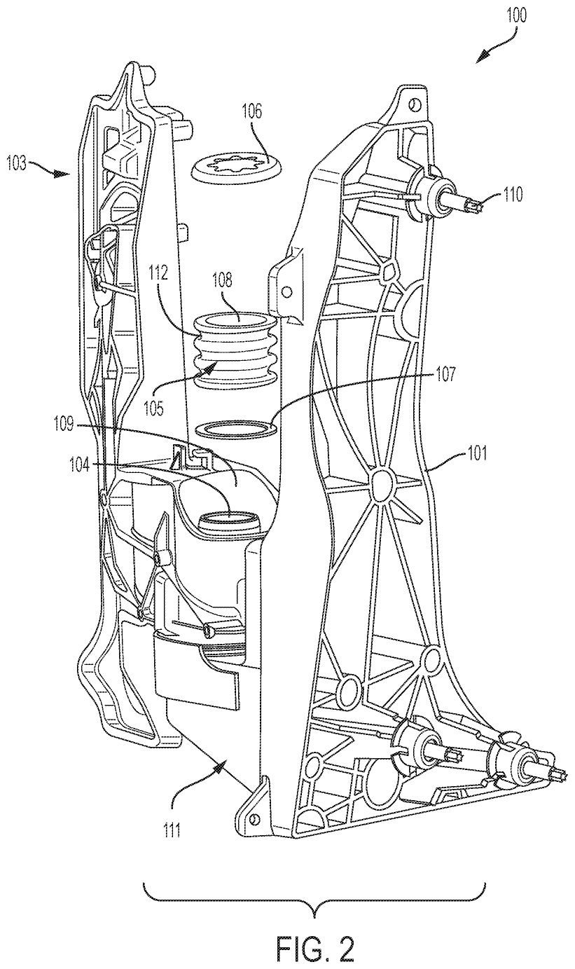

Referring to FIG. 2, an example of a lateral rearview mirror system 100 of this disclosure is depicted. In FIG. 2, lateral rearview mirror system 100 comprises a base bracket 101 for mounting the lateral rearview mirror system 100 to the door of a vehicle (not shown). The base bracket 101 generally has a mounting surface 110 for mounting the base bracket 101 to the door of a vehicle and an arm 111 on a surface opposite the mounting surface 110 and extending away from the mounting surface 110.

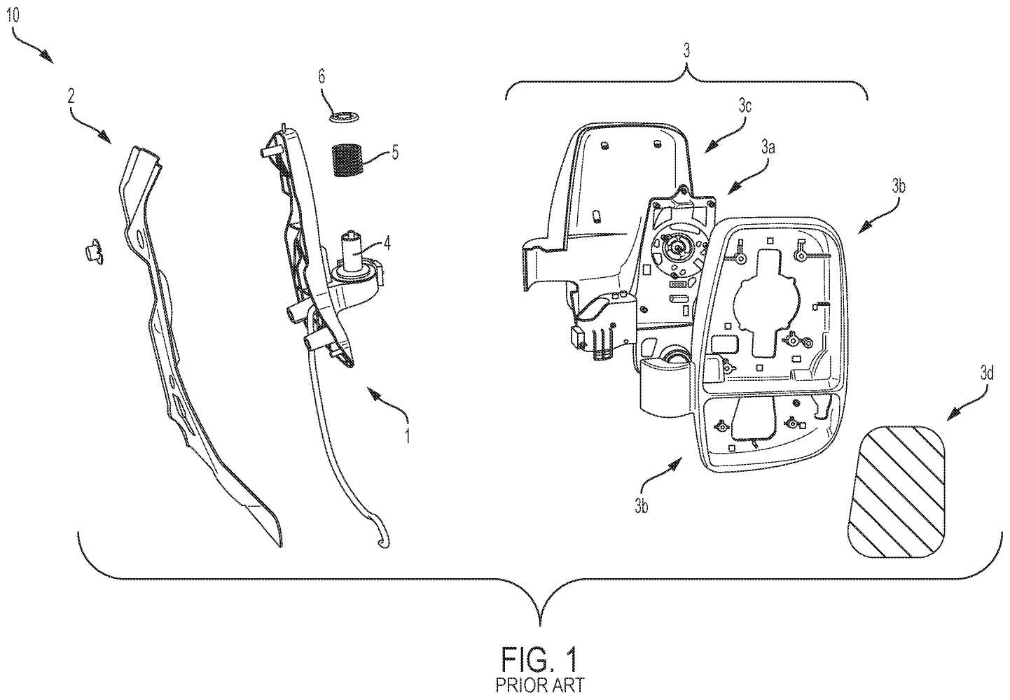

A support 104 is preferably integrated with the arm 111 of the base bracket 101 or formed separately and mounted thereon. Like the support 4 depicted in FIG. 1, the support 104 is generally a cylindrical structure extending upwardly from a base portion positioned on arm 111.

As depicted, lateral rearview mirror system 100 further comprises mirror assembly 103 mountable to the base bracket 101. The mirror assembly 103 comprises housing bracket 103a for providing structural support and mounting surface for additional components of the mirror assembly 103, such the a reflective element (as shown in FIG. 1). While not shown in FIG. 2, it should be understood that mirror assembly 103 may further include a front housing and back housing similar to those depicted in FIG. 1 or other like structures.

Optionally, one or more portions of the lateral rearview mirror system 100 may be formed from a non-metal material. For example, at least one of the support 104, the housing bracket 103a or the base bracket 101 may be comprised of a non-metal material. However, it should be understood that all of housing bracket 103a, support 104 and base bracket 101 can be formed from metal or non-metal material without departing from the invention.

Suitable metal materials for forming elements of the lateral rearview mirror system 100 include but are not limited to aluminum, steel, magnesium and alloys thereof. Suitable non-metal materials for forming elements of the lateral rearview mirror system 100 include but are not limited to polybutylene terephthalate, polyamides, polypropylene, thermo plastic, acrylonitrile butadiene styrene (ABS) or suitable resinous plastic, or the like. A specific suitable example includes resinous plastic commercially available under the trademark Ultradur® and Ultramid® by BASF Company of Wyandotte, Mich.

In lieu of a metal spring 5, the lateral rearview mirror system 100 further includes a vibration dampener 105 positioned on the support 104 between the base bracket 101 and mirror assembly 103. The vibration dampener 105 is cylindrical and has a cavity 108 for receiving a portion of the support 104. The cavity 108 may pass through the vibration dampener 105 such that the vibration dampener 105 has a tubular shape. Together, the mirror assembly 103 and the support 104 define an enclosed space 109 housing the vibration dampener 105. The vibration dampener 105 is axially compressible within the enclosed space 109.

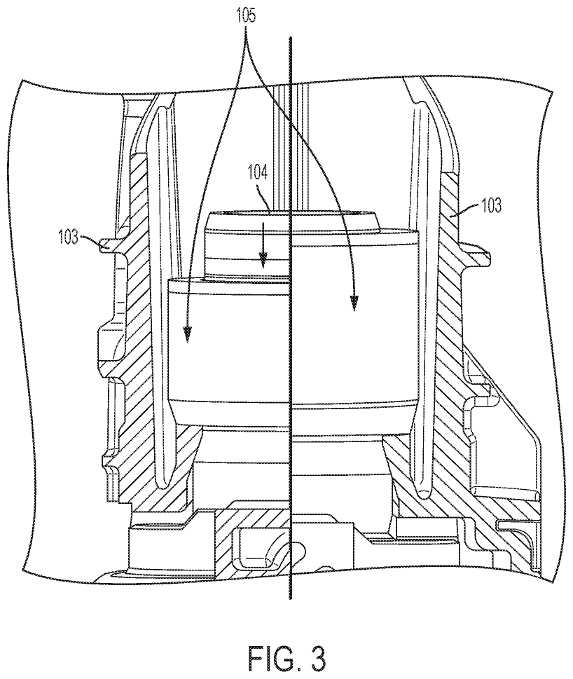

As best seen in FIG. 3, when assembled in the lateral rearview mirror system 100, the elastomeric vibration dampener 105 is positioned in the mirror assembly 103 in a compressed state. Compression of the vibration dampener 105 causes the vibration dampener 105 to apply a biased force against the mirror assembly 103 and further aids in the vibration dampener 105 absorbing vibrational energy transfer between the mirror assembly 103 and the base bracket 101 to reduce the energy transmission percentage from the base bracket 101 to the mirror assembly 103.

Preferably, the vibration dampener 105 is formed from an elastomeric material that is compressible with low lateral expansion, making it suitable for applications where surrounding structural space is confined. Suitably, the vibration dampener 105 may be formed from microcellular polyurethane that has a microcellular structure having cell walls defining a plurality of cells, or void space, with a portion of the cells being open. The cell walls have an original shape and the cells are generally filled with air. When the microcellular polyurethane is subjected to compressive forces, the cell walls collapse and air evacuates from the cells. When the compressive forces are removed, the cell walls return to the original shape. The use of microcellular urethane is beneficial in compression applications because the microcellular polyurethane has a progressive load deflection curve.

An example of a suitable microcellular polyurethane is the type manufactured by BASF Corporation under the trade name CELLASTO®, including CELLASTO® SM72. The microcellular polyurethane may be formed from a two-step process. In the first step of this exemplary process, an isocyanate prepolymer is formed by reacting a polyol and an isocyanate. The polyol is a polyester polyol, alternatively a polyether polyol. The isocyanate is monomeric methyldiphenyl diisocyanate, alternatively naphthalene diisocyanate. However, it should be appreciated that the isocyanate can be of any type without departing from the nature of the present invention. In the second step of this exemplary process, the isocyanate prepolymer reacts with water to generate carbon dioxide and the carbon dioxide forms the cells of the microcellular polyurethane.

Polyester polyols that are produced from the reaction of a dicarboxylic acid and a glycol having at least one primary hydroxyl group are possible for use to make the microcellular polyurethane. Dicarboxylic acids that are suitable for producing the polyester polyols are selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for producing the polyester polyols are selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof. The polyester polyol has a hydroxyl number of from 30 to 130, a nominal functionality of from 1.9 to 2.3, and a nominal molecular weight of from 1000 to 3000. Specific examples of polyester polyols suitable for the subject invention include PLURACOL® Series commercially available from BASF Corporation of Florham Park, N.J.

Polyether polyols are produced from the cyclic ether propylene oxide, alternatively ethylene oxide or tetrahydrofuran. Propylene oxide is added to an initiator in the presence of a catalyst to produce the polyether polyol. Suitable polyether polyols are selected from the group of, but are not limited to, polytetramethylene glycol, polyethylene glycol, polypropylene glycol, and combinations thereof. The polyether polyol has a hydroxyl number of from 30 to 130, a nominal functionality of from 1.8 to 2.3, and a nominal molecular weight of from 1000 to 5000. Specific examples of polyether polyols suitable for the subject invention include Pluracol® 858, PLURACOL® 538, PLURACOL® 220, PLURACOL® TP Series, PLURACOL® GP Series, and PLURACOL® P Series commercially available from BASF Corporation of Florham Park, N.J.

Diisocyanates suitable to make the microcellular polyurethane are selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-di isocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof. Specific examples of diisocyanates suitable for the subject invention include LUPRANATE® 5143, LUPRANATE® MM103, and LUPRANATE® R2500U commercially available from BASF Corporation of Florham Park, N.J.

The monomeric methyldiphenyl diisocyanate is selected from the group of 4,4′-diphenylmethane diisocyanate, 2,4′-diphenylmethane diisocyanate, and combinations thereof. Specific examples of monomeric methyldiphenyl diisocyanates suitable for the subject invention include LUPRANATE® M and LUPRANATE® MS commercially available from BASF Corporation of Florham Park, N.J. The monomeric methyldiphenyl diisocyante may also be modified with carbonimide. Specific examples of carbonimide-modified monomeric methyldiphenyl diisocyante include LUPRANATE® 5143 and LUPRANATE® MM103 commercially available from BASF Corporation of Florham Park, N.J.

Preferably, the vibration dampener 105 is formed from a microcellular polyurethane material having a density between 200 kg/m³ and 800 kg/m³. More preferably, the vibration dampener has a density greater than 270 kg/m³ or, more preferably greater than 350 kg/m³. Preferably, the vibration dampener has a density of less than 650 kg/m³.

Optionally, lateral rearview mirror system 100 may further comprise a washer 107 positioned between an end of the vibration dampener 105 and the base bracket 101. Additionally, the lateral rearview mirror system 100 may optionally comprise a metal retainer 106 positioned on an end of the vibration dampener 105 opposite the arm 111 base bracket 101.

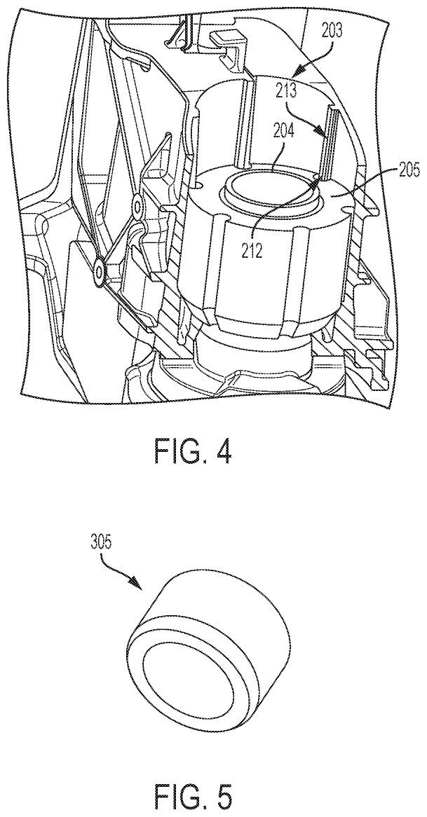

Optionally, the vibration dampener 105 may have grooves on an outer surface. As can be seen from the exemplary vibration dampener 105 depicted in FIG. 2, the grooves 112 may be circumferential such that the outer surface of the vibration dampener 105 is circumferentially corrugated. Circumferential grooves may advantageously facilitate the compressibility of vibration dampener 105. Alternatively, FIG. 4 depicts an exemplary vibration dampener 205 showing that the grooves 212 may be axially-oriented. If included, axially-oriented grooves 212 may be configured to correspond to ridges 213 in the mirror assembly 203, as seen best in FIG. 4. The corresponding grooves 212 and ridges 213 may interlock such that rotational movement the mirror assembly 203 causes a corresponding rotational movement in the vibration dampener 205. In yet another example depicted in FIG. 5, the vibration dampener 305 may have a smooth surface free of grooves.

This disclosure further provides a method of making a vibration-resistant lateral rearview mirror system 100. The method comprises providing a base bracket 101 for mounting the lateral rearview mirror system 100 to a vehicle, the base bracket 101 having a support 104 integrated therewith or mounted thereon. An elastomeric vibration dampener 105 is positioned on the support 104 and a mirror assembly 103 having a reflective element is coupled to the support 104 with the vibration dampener 105 enclosed within the mirror assembly 103 in a compressed state. Optionally, a washer 107 may be positioned between the vibration dampener 105 and the base bracket 101 before positioning the vibration dampener 105 on the support 104. Additionally, an optional metal retainer 106 may be positioned on an end of the vibration dampener 105 facing away from a base of the support 104.

As will be apparent to those skilled in the art, our systems and methods reside in the combination of parts set forth in this disclosure and covered by the claims appended hereto, it being understood that changes in the precise structure and steps herein disclosed may be made within the scope of what is claimed without departing from the spirit of the disclosure.

1. A vibration-resistant lateral rearview mirror system comprising:
a base bracket for mounting the lateral rearview mirror system to a vehicle;
a mirror assembly having a reflective element;
a support on the base bracket for mounting the mirror assembly to the base bracket;
an elastomeric vibration dampener positioned in the mirror assembly in a compressed state, wherein the vibration dampener applies a biased force against the mirror assembly and absorbs vibrational energy transferred between the mirror assembly and the base bracket.

2. The vibration-resistant lateral rearview mirror system of claim 1, wherein the vibration dampener is cylindrical and has a cavity for receiving a portion of the support.

3. The vibration-resistant lateral rearview mirror system of claim 1, wherein the mirror assembly and the support define an enclosed space housing the vibration dampener.

4. The vibration-resistant lateral rearview mirror system of claim 3, wherein the vibration dampener is axially compressible within the enclosed space.

5. The vibration-resistant lateral rearview mirror system of claim 1, wherein the vibration dampener has grooves on an outer surface.

6. The vibration-resistant lateral rearview mirror system of claim 5, wherein the grooves are axially-oriented.

7. The vibration-resistant lateral rearview mirror system of claim 5, wherein the grooves are circumferential.

8. The vibration-resistant lateral rearview mirror system of claim 1, further comprising a washer positioned between an end of the vibration dampener and the base bracket.

9. The vibration-resistant lateral rearview mirror system of claim 1, further comprising a metal retainer positioned on an end of the vibration dampener facing away from a base of the support.

10. The vibration-resistant lateral rearview mirror system of claim 1, wherein the elastomeric material comprises a plurality of cells and a portion of the cells are open.

11. The vibration-resistant lateral rearview mirror system of claim 1, wherein the vibration dampener comprises a polyurethane.

12. The vibration-resistant lateral rearview mirror system of claim 1, wherein the vibration dampener comprises a microcellular polyurethane elastomeric material.

13. The vibration-resistant lateral rearview mirror system of claim 1, wherein the vibration dampener has a density between 200 kg/m³ and 800 kg/m³ between 270 kg/m³ and 650 kg/m³ or between 350 kg/m³ and 650 kg/m³.

14. (canceled)

15. (canceled)

16. The vibration-resistant lateral rearview mirror system of claim 1, wherein at least one of the support or the base bracket is comprised of a non-metal material.

17. A method of making a vibration-resistant lateral rearview mirror system comprising:
providing a base bracket for mounting the lateral rearview mirror system to a vehicle, the base bracket comprising a support;
positioning an elastomeric vibration dampener on the support; and
coupling a mirror assembly having a reflective element to the support,
wherein the vibration dampener is enclosed within the mirror assembly in a compressed state.

18. The method of claim 17, wherein the vibration dampener is cylindrical and has a cavity and the vibration dampener is positioned on the support so that the cavity of the vibration dampener receives a portion of the support.

19. The method of claim 17, further comprising positioning a washer between the vibration dampener and the base bracket.

20. The method of claim 17, further comprising positioning a metal retainer on an end of the vibration dampener facing away from a base of the support.

21. The method of claim 17, wherein the vibration dampener comprises a polyurethane.

22. The method of claim 17, wherein the vibration dampener comprises a microcellular polyurethane elastomeric material.

23. (canceled)

24. (canceled)
